(19) United States
(12) Patent Application Publication
(10) Pub. No.: US 2025/0164196 A1
(43) Pub. Date: May 22, 2025

(54) METHOD FOR MANUFACTURING HEAT EXCHANGER, HEAT EXCHANGER, AND HVAC APPARATUS

(71) Applicants: GD MIDEA HEATING & VENTILATING EQUIPMENT CO., LTD., Foshan (CN); MIDEA GROUP CO., LTD., Foshan (CN)

(72) Inventors: Zhifang LI, Foshan (CN); Xiaofan JIN, Foshan (CN); Lele XU, Foshan (CN); Yuzhao LUO, Foshan (CN)

(21) Appl. No.: 18/893,524

(22) Filed: Sep. 23, 2024

(30) Foreign Application Priority Data
Nov. 21, 2023 (CN) 202311563605.7
Dec. 6, 2023 (CN) 202311670103.4

(51) Int. Cl. F28F 1/12; B23K 1/00; B23K 101/14; F28F 21/08

(52) U.S. Cl. CPC F28F 1/12; B23K 1/0012; F28F 21/081; B23K 2101/14; F28F 2275/06

(57) ABSTRACT

A method for manufacturing a heat exchanger includes providing a fin and a heat exchange tube. A welding hole is arranged at the fin, and flow guide teeth are arranged at an inner wall of the heat exchange tube. The method further includes passing the heat exchange tube through the welding hole, and welding the fin and the heat exchange tube at a position of the welding hole.

### CROSS-REFERENCE TO RELATED APPLICATIONS

The present application claims priority to Chinese patent application No. 202311563605.7, filed with the China National Intellectual Property Administration on Nov. 21, 2023, and entitled “Method for Manufacturing Heat Exchanger, Heat Exchanger, and HVAC Apparatus”; and Chinese patent application No. 202311670103.4, filed with the China National Intellectual Property Administration on Dec. 6, 2023, and entitled “Method for Manufacturing Heat Exchanger, Heat Exchanger, and HVAC Apparatus,” the entire contents of both of which are incorporated herein by reference.

### TECHNICAL FIELD

The present application relates to the technical field of heat exchange apparatuses, and specifically relates to a method for manufacturing a heat exchanger, a heat exchanger, and an HVAC (heating, ventilation and air conditioning) apparatus.

### BACKGROUND

This section only provides background information related to the present disclosure, which is not necessarily prior art.

In finned heat exchangers, heat exchange tubes are usually fixedly connected to fins in an interference fit manner, in which mechanical tube expansion is used for bonding. There are contact thermal resistances at the connection positions between the heat exchange tubes and the fins, and the contact thermal resistances will affect the heat exchange between the heat exchange tubes and the fins. On the other hand, the heat exchange tubes and the fins are connected by mechanical tube expansion, which will also wear out internal teeth arranged at the heat exchange tubes, thereby affecting the heat exchange efficiency of the heat exchanger.

### SUMMARY

An object of the present application is to at least alleviate the technical problem of low heat exchange efficiency of heat exchangers, and this object is achieved through the following technical solutions.

A first aspect of the present application provides a method for manufacturing a heat exchanger, which includes:
providing at least one fin and at least one heat exchange tube, in which a welding hole is arranged at the fin, and flow guide teeth are arranged at an inner wall of the heat exchange tube;
passing the heat exchange tube through the welding hole; and
welding the fin and the heat exchange tube at the position of the welding hole.

In the method for manufacturing a heat exchanger of the present application, a welding hole is provided on the fin of the heat exchanger, and the heat exchange tube is passed through the welding hole and welded together with the fin. The heat exchange tube is connected to the fin by welding, so that the heat exchange tube and the fin are connected by a welding material, resulting in higher heat transfer efficiency and therefore alleviating the problem of low efficiency of the heat exchanger caused by the contact thermal resistance between the heat exchange tube and the fin.

In the method for manufacturing a heat exchanger of the present application, when the flow guide teeth inside the heat exchange tube are located at the position of the welding hole on the fin, the heat exchange tube is connected to the fin by welding, which also avoids different degrees of wear of the flow guide teeth inside the heat exchange tube caused by mechanical tube expansion. The heat exchange tube with worn out flow guide teeth will also affect heat exchange of the heat exchange tube. Therefore, in the method for manufacturing a heat exchanger of the present application, the integrity of the flow guide teeth on the inner wall of the heat exchange tube is maintained during the manufacturing process, so that the heat exchange area of the heat exchange tube and the heat exchange efficiency of the entire heat exchanger are increased.

In addition, the method for manufacturing a heat exchanger of the present application may also have the following additional technical features.

In some embodiments of the present application, before welding the fin and the heat exchange tube at the position of the welding hole, the method further includes:
covering an outer surface of the heat exchange tube with a solder layer.

In some embodiments of the present application, before welding the fin and the heat exchange tube at the position of the welding hole, the method further includes:
covering an outer surface of the fin with a solder layer, or covering an area to be welded at the welding hole with a solder layer.

In some embodiments of the present application, before welding the fin and the heat exchange tube at the position of the welding hole and after the step of passing the heat exchange tube through the welding hole, the method further includes:
spraying welding flux at the position of the welding hole of the fin and an area to be welded of the heat exchange tube respectively.

In some embodiments of the present application, the method for manufacturing a heat exchanger further includes a step of processing the heat exchange tube, which includes:
providing a heat exchange tube body; and
bending the heat exchange tube body into a U-shaped heat exchange tube.

In some embodiments of the present application, the covering an outer surface of the heat exchange tube with a solder layer includes:
soaking the outer surface of the heat exchange tube in a solder solution to form a solder layer on the outer surface of the heat exchange tube.

In some embodiments of the present application, the step of welding the fin and the heat exchange tube at the position of the welding hole includes:
fixing the heat exchange tube passed through the welding hole and the fin so that they maintain an attitude for welding;
placing the heat exchange tube and the fin that maintain the attitude for welding inside a heating furnace; and
welding the heat exchange tube and the fin at the position of the welding hole using automatic welding.

In some embodiments of the present application, the heat exchange tube is made of aluminum-based material and/or copper-based material.

In some embodiments of the present application, the step of providing at least one heat exchange tube further includes:
integrally forming the heat exchange tube with the flow guide teeth on its inner wall, in which the flow guide teeth are used for heat exchange with a medium inside the heat exchange tube.

A second aspect of the present application provides a heat exchanger, which includes:
at least one fin, on which a welding hole is provided; and
at least one heat exchange tube, an inner wall of which is provided with flow guide teeth;
the heat exchange tube is passed through the welding hole and fixedly connected by welding.

A third aspect of the present application provides an HVAC apparatus, which includes the heat exchanger as described above.

### BRIEF DESCRIPTION OF THE DRAWINGS

Upon reading the detailed description of embodiments below, various other advantages and benefits will become clear to those skilled in the art. The accompanying drawings are only used for the purpose of illustrating some embodiments, and should not be considered as a limitation to the present disclosure. Moreover, throughout the drawings, the same reference signs are used to denote the same components. In the drawings:

FIG. 1 is a schematic diagram showing the method for manufacturing a heat exchanger of a first embodiment of the present application;

FIG. 2 is a schematic diagram showing the method for manufacturing a heat exchanger of a second embodiment of the present application;

FIG. 3 is a schematic diagram showing the method for manufacturing a heat exchanger of a third embodiment of the present application;

FIG. 4 is a schematic diagram showing the method for manufacturing a heat exchanger of a fourth embodiment of the present application;

FIG. 5 is a schematic diagram showing the method for manufacturing a heat exchanger of a fifth embodiment of the present application;

FIG. 6 is a schematic diagram showing the method for manufacturing a heat exchanger of a sixth embodiment of the present application;

FIG. 7 is a schematic diagram showing the method for manufacturing a heat exchanger of a seventh embodiment of the present application;

FIG. 8 shows a schematic structural diagram of the fins of the heat exchanger of the present application;

FIG. 9 shows a schematic structural diagram of the heat exchange tubes of the heat exchanger of the present application; and

FIG. 10 shows a schematic structural diagram of the heat exchanger of the present application after the combination of the heat exchange tubes and the fins.

### LIST OF REFERENCE SIGNS

100: fin; 110: welding hole;
200: heat exchange tube; 210: flow guide teeth; 220: U-shaped heat exchange tube;
300: heat exchanger.

### DETAILED DESCRIPTION

Hereinafter, exemplary embodiments of the present disclosure will be described in greater detail with reference to the accompanying drawings. Although the exemplary embodiments of the present disclosure are shown in the drawings, it should be understood that the present disclosure may be implemented in various forms and should not be limited by the embodiments set forth herein. On the contrary, these embodiments are provided to enable a more thorough understanding of the present disclosure and to fully convey the scope of the present disclosure to those skilled in the art.

It should be understood that the terms used herein are only for the purpose of describing specific exemplary embodiments, and are not intended to be limitative. Unless clearly indicated otherwise in the context, singular forms “a,” “an,” and “said” as used herein may also mean that plural forms are included. Terms “include,” “comprise,” “contain” and “have” are inclusive, and therefore indicate the existence of the stated features, steps, operations, elements and/or components, but do not exclude the existence or addition of one or more other features, steps, operations, elements, components, and/or combinations thereof. The method steps, processes, and operations described herein should not be interpreted as requiring them to be executed in the specific order described or illustrated, unless the order of execution is clearly indicated. It should also be understood that additional or alternative steps may be used.

Although terms “first,” “second,” “third” and the like may be used herein to describe multiple elements, components, regions, layers and/or sections, these elements, components, regions, layers and/or sections should not be limited by these terms. These terms may only be used to distinguish one element, component, region, layer or section from another region, layer or section. Unless clearly indicated in the context, terms such as “first,” “second” and other numerical terms do not imply an order or sequence when they are used herein. Therefore, the first element, component, region, layer or section discussed below may be referred to as a second element, component, region, layer or section without departing from the teachings of the exemplary embodiments.

For ease of description, spatial relative terms may be used herein to describe the relationship of one element or feature relative to another element or feature as shown in the drawings. These relative terms are, for example, “inner,” “outer,” “inside,” “outside,” “below,” “under,” “above,” “over,” etc. These spatial relative terms are intended to include different orientations of the device in use or in operation in addition to the orientation depicted in the drawings. For example, if the device in the figure is turned over, then elements described as “below other elements or features” or “under other elements or features” will be oriented “above the other elements or features” or “over the other elements or features.” Thus, the exemplary term “below” may include orientations of both above and below. The device can be otherwise oriented (rotated by 90 degrees or in other directions), and the spatial relationship descriptors used herein will be explained accordingly.

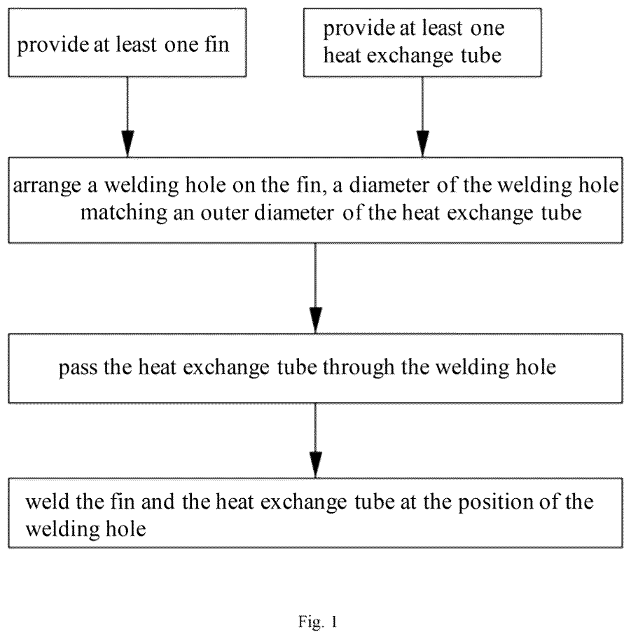

The present application provides a method for manufacturing a heat exchanger, which reduces the contact thermal resistance between the heat exchange tubes and the fins inside the heat exchanger. Compared with the existing connection between the heat exchange tubes and the fins using mechanical tube expansion, the heat exchange tubes and the fins are connected by welding material, which is evenly arranged at the connection positions of the heat exchange tubes and the fins, thereby improving the heat exchange efficiency between the heat exchange tubes and the fins and therefore enhancing the heat exchange efficiency of the whole heat exchanger. At the same time, the heat exchange tubes and the fins are connected by welding material, so that the connection area is larger and the connection is firmer. In some embodiments, referring to FIG. 1, the method for manufacturing a heat exchanger in the embodiment of the present application includes the following steps:
providing at least one fin, and at least one heat exchange tube with flow guide teeth on an inner wall thereof,
providing a welding hole on the fin, in which a diameter of the welding hole matches an outer diameter of the heat exchange tube;
passing the heat exchange tube through the welding hole; and
welding the fin and the heat exchange tube at the position of the welding hole.

In the method for manufacturing a heat exchanger of the embodiment of the present application, the heat exchange tube and the fin are welded at the position of the welding hole to achieve fixed connection, which also achieves the following technical effect: the flow guide teeth on the inner wall of the heat exchange tube avoid different degrees of wear caused by the connection between the heat exchange tube and the fin implemented through mechanical tube expansion. Therefore, during the manufacturing process of the heat exchanger, it is ensured that the flow guide teeth inside the heat exchange tube are in an intact condition, thereby increasing the heat exchange area of the heat exchange tube and therefore improving the heat exchange efficiency of the whole heat exchanger.

In the step of “passing the heat exchange tube through the welding hole,” the section of the tube with flow guide teeth arranged at the inner wall of the heat exchange tube can also be passed to the position of the welding hole of the fin, since the welding process of the heat exchange tube and the fin reduces and avoids damage to the flow guide teeth on the inner wall of the heat exchange tube, making the heat exchange tube have a larger heat exchange area.

After the step of “passing the heat exchange tube through the welding hole,” the fin and the heat exchange tube should also be fixed to maintain the fin and the heat exchange tube in an attitude required for the welding process. For the specific fixing means, fixtures can be used, or specialized apparatuses for fixing the heat exchange tube and the fin can be used.

The heat exchanger manufactured according to the manufacturing method of the present application can be provided with multiple heat exchange tubes and multiple fins, and the multiple heat exchange tubes can be connected to the multiple fins respectively to improve the heat exchange efficiency of the heat exchanger.

In the method for manufacturing a heat exchanger of the embodiment of the application, in the step of “providing a welding hole on the fin, in which a diameter of the welding hole matches an outer diameter of the heat exchange tube,” the function of the welding hole is to connect the heat exchange tube with the fin and fix them by welding. The diameter of the welding hole should match the outer diameter of the heat exchange tube, that is, the diameter of the welding hole should meet the welding process of the fin and the heat exchange tube. The diameter of the welding hole can be slightly larger than the outer diameter of the heat exchange tube, so that the welding hole of the fin and the heat exchange tube can be in clearance fit, and the clearance should be suitable for filling with welding material after welding between the fin and the heat exchange tube. The welding hole should be a through hole for the heat exchange tube to pass through.

When multiple fins are arranged in the method for manufacturing a heat exchanger of the embodiment of the present application, each of the fins should be provided with a welding hole, and the heat exchange tube is passed through the welding holes and are connected to the multiple fins arranged at intervals. When multiple heat exchange tubes are arranged, each of the heat exchange tubes is connected to the fin, and multiple welding holes can be provided on each fin to connect with multiple heat exchange tubes, so as to improve the heat exchange capacity of the heat exchanger and increase heat exchange amount.

In the method for manufacturing a heat exchanger of the embodiment of the present application, in the step of passing the heat exchange tube through the welding hole and fixing the relative positional relationship between the fin and the heat exchange tube, the heat exchange tube is passed through the welding hole so that the heat exchange tube and the fin can be welded; when there are multiple fins in the heat exchanger, welding holes are provided on the multiple fins respectively; the multiple fins are sequentially arranged at intervals, and the heat exchange tube is passed through the welding holes on the multiple fins;
when the heat exchanger is provided with multiple heat exchange tubes, multiple welding holes are arranged at the fins, and each heat exchange tube is sequentially passed through the welding holes on the fins arranged at intervals;
the relative positional relationship between the fins and the heat exchange tubes can be fixed by using fixtures for assistance; in further embodiments, the method includes arranging the heat exchange tubes vertically on the fixtures, sleeving the fins onto the heat exchange tubes by welding, and using the fixtures to maintain the relative positional relationship between the heat exchange tubes and the fins.

When the heat exchanger is provided with multiple heat exchange tubes and multiple fins, the multiple fins are sequentially passed onto the multiple heat exchange tubes through the welding holes, adjacent fins are spaced apart, and the relative positional relationship between the multiple fins and the multiple heat exchange tubes is maintained using fixtures.

In the method for manufacturing a heat exchanger of the embodiment of the present application, in the step of welding the fin and the heat exchange tube at the position of the welding hole, the welding hole areas between the fins and the heat exchange tubes are sequentially welded to fix the relative positional relationship between the fins and the heat exchange tubes. After the welding process is completed for all the welding hole areas, the relative positional relationship between the fins and the heat exchange tubes is fixed, and the welded fins and heat exchange tubes can be removed from the fixtures to continue processing and manufacturing the heat exchanger.

The method for manufacturing a heat exchanger also includes the installation of a support assembly, the installation of a shell, and the installation and fixation of a spray assembly, etc.

In the method for manufacturing a heat exchanger of the embodiment of the present application, the fins and the heat exchange tubes are connected by welding, which is different from the existing connection using mechanical tube expansion, making the heat exchanger have higher heat exchange efficiency.

It should be noted that in the method for manufacturing a heat exchanger of the embodiment of the present application, the heat exchange tubes can be made of aluminum-based materials, making the heat exchange tubes more corrosion-resistant; this is because aluminum-based materials have excellent anti “ant hole corrosion” performance, as well as other advantages such as low cost and recycling. Aluminum-based materials include aluminum alloys and the like, and specific profiles thereof can be aluminum round tubes and aluminum flat tubes, with local parts being aluminum bent components or elbows, etc.

The heat exchange tubes can also be made of copper-based materials, the excellent thermal conductivity of which makes the heat exchanger have high heat exchange efficiency.

In an embodiment of the method for manufacturing a heat exchanger of the present application, the heat exchange tubes and the fins of the heat exchanger are both made of aluminum-based materials. During the welding process, the heat exchange tubes are welded to the welding holes on the fins by controlling the temperature of welding flame. The temperature fluctuation of the welding flame during the welding process should be small; for example, the temperature fluctuation is controlled below 50° C. In further embodiments, when the welding material melts at 660° C., the temperature of the welding flame should be controlled between 630° C. and 680° C.; and when the welding material melts at 640° C., the temperature of the welding flame should be controlled within the range of 600° C. to 650° C. The purpose of this setting is to reduce the deformation impact on the heat exchange tubes and fins made of aluminum-based materials during the welding process. At the same time, the heat exchange tubes and the fins in this embodiment are made of the same aluminum-based material, which is advantageous for controlling the welding flame within a reasonable range.

The heat exchange tubes and the fins of the heat exchanger can also be made of copper-based materials, or other metal materials of the same type.

In the method for manufacturing a heat exchanger of the embodiment of the present application, the method includes the step of providing flow guide teeth on the inner wall of the heat exchange tube, so as to form a tooth shaped structure for increasing the heat conduction area; the tooth shaped structure is arranged inside the heat exchange tube, and when the refrigerant medium passes through the interior of the heat exchange tube, the refrigerant medium comes into contact with the tooth shaped structure inside the heat exchange tube, which is equivalent to increasing the heat exchange area between the heat exchange tube and the refrigerant medium. Therefore, by providing the tooth shaped structure inside the heat exchange tube, the heat exchange amount of the heat exchange tube per unit time is increased, and the heat exchange efficiency of the heat exchanger is improved.

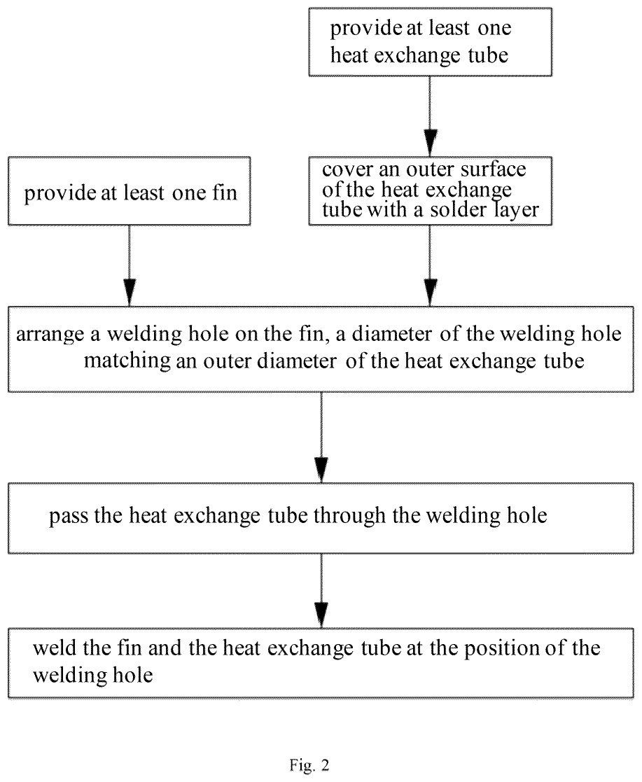

In an embodiment of the method for manufacturing a heat exchanger of the present application, with reference to FIG. 2, after providing at least one heat exchange tube, the manufacturing method further includes covering an outer surface of the heat exchange tube with a solder layer. In this embodiment, the heat exchange tube with the solder layer is passed into the welding hole of the fin, the heat exchange tube and the fin are welded and fixed together by welding in the area near the welding hole, and the outer surface of the heat exchange tube is covered with a solder layer. When the solder is heated and melted, it is more uniformly bonded to the heat exchange tube, thereby making the connection between the fin and the heat exchange tube firmer.

Especially, when the heat exchange tube of the heat exchanger is made of aluminum-based material, the outer surface of the heat exchange tube made of aluminum-based material is covered with a solder layer. The melted solder layer fixes and connects the heat exchange tube and the fin, making the welding of the heat exchange tube made of aluminum-based material firmer. At the same time, the aluminum-based material has excellent characteristic of anti “ant hole corrosion,” thus improving the service life of the heat exchange tube in the heat exchanger.

Covering the outer surface of the heat exchange tube with a solder layer is also advantageous for achieving automatic welding between the heat exchange tube and the fin. When multiple heat exchange tubes are arranged in the heat exchanger, the outer surfaces of the multiple heat exchange tubes are all covered with solder layers. The multiple heat exchange tubes are respectively passed through the welding holes of the fins and heated in a heating furnace, causing the solder of the multiple heat exchange tubes near the welding holes to melt simultaneously. The multiple heat exchange tubes are welded and fixed to the fins simultaneously, greatly improving the manufacturing efficiency of the heat exchanger.

It should be noted that the heat exchange tube with the solder layer and the welding hole of the fin should be a clearance fit. On one hand, the welding hole should be suitable for the heat exchange tube with the solder layer to freely pass through it; on the other hand, the welding hole should meet the welding process of the heat exchange tube and the fin. When the welding process is completed, the heat exchange tube and the fin should be firmly connected together using the solder to minimize the influence of the contact thermal resistance between the heat exchange tube and the fin on heat exchange.

When the heat exchange tube of the heat exchanger is made of aluminum-based material, a step of arranging flow guide teeth inside the heat exchange tube can be added in the step of providing at least one heat exchange tube. By increasing the flow guide teeth inside the heat exchange tube made of aluminum-based material, the heat exchange amount per unit area of the heat exchange tube can be increased, thereby improving the overall heat exchange efficiency of the heat exchanger.

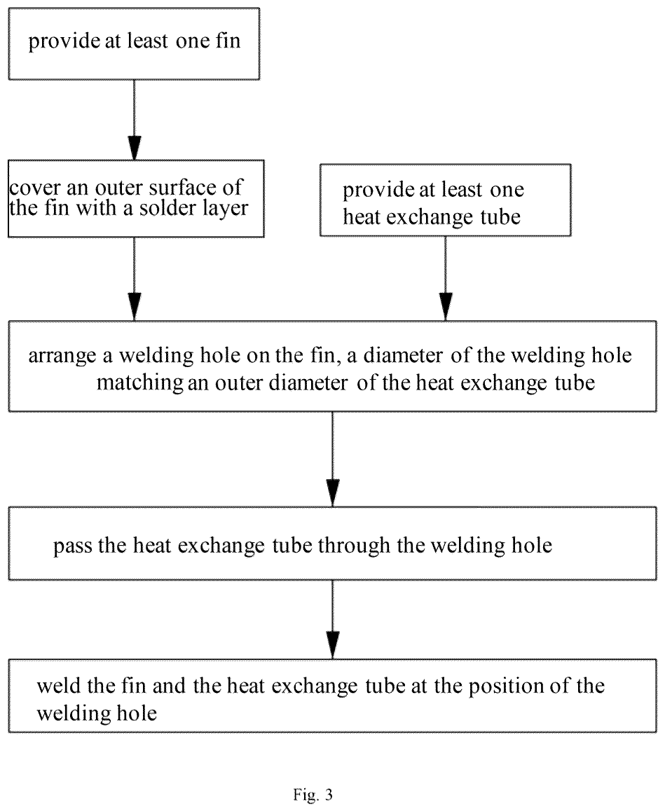

In an embodiment of the method for manufacturing a heat exchanger of the present application, referring to FIG. 3, in the step of providing at least one fin, the manufacturing method further includes: covering an outer surface of the fin with a solder layer. By covering the outer surface of the fin with a solder layer, after the heat exchange tube is passed through the welding hole of the fin, the fin and the heat exchange tube are welded and fixed more firmly. In this embodiment, the fin of the heat exchanger is a complex fin. Before the welding process of the fin and the heat exchange tube begins, the solder layer is covered on the outer surface of the fin to increase the connection strength of the fin after welding.

The solder layer is uniformly arranged at the overall outer surface of the fin, and the fin is processed into a complex fin, so that the processing efficiency of the fin is improved. Especially when multiple complex fins need to be manufactured, the solder layers of the multiple fins can be processed simultaneously, which improves the production efficiency. Alternatively, after the entire complex fin is manufactured, it can be divided into multiple independent fins suitable for arrangement in the heat exchanger. The multiple independent fins can be arranged at intervals in the heat exchanger to improve the heat exchange efficiency of the heat exchanger.

It is also possible to cover the area near the welding hole of the fin with a solder layer. Covering the local area of the fin with the solder layer can save the amount of solder used and is advantageous for cost saving. Especially in case of mass processing and manufacturing of the fins with solder layers, the solder layers only need to be arranged in the areas of the welding holes where the fins need to be welded, which not only improves the welding connection strength of the fins, but also saves the amount of solder used.

In the method for manufacturing a heat exchanger of this embodiment, a solder layer is arranged at the outer surface of the fin, and a solder layer uniformly covers an area to be welded at the welding hole of the fin. When the solder layers are heated and melted, they are uniformly and tightly connected to the fin substrate, improving the connection strength between the fin substrate and the solder, as well as between the fin substrate and the heat exchange tube. When there is good connection reliability between the fin and the heat exchange tube, the heat exchange between the heat exchange tube and the fin is more efficient, reducing the influence of the contact thermal resistance between the fin and the heat exchange tube on heat exchange.

Arranging the solder layer on the outer surface of the fin of the heat exchanger is advantageous for achieving automatic welding. When the heat exchanger tube is passed through the welding hole of the fin and the relative position between the heat exchanger tube and the fin is fixed, the welding hole area of the fin is heated, so that the solder layer in the welding hole area is melted and connected with the heat exchanger tube. The manufacturing method of this embodiment is applicable to an embodiment in which multiple fins are arranged in the heat exchanger: each fin is provided with multiple welding holes, and by heating the multiple fins simultaneously, the multiple fins are welded to the heat exchanger tube at the positions of the welding holes, which improves the welding efficiency and is more advantageous for shortening the processing time of the entire heat exchanger, reserving more time for other processes of the heat exchanger.

In the method for manufacturing a heat exchanger of this embodiment, the step of fixing the relative position of the heat exchange tube and the fin further includes using a fixture to assist in fixing the relative position of the heat exchange tube and the fin, in which the fixture has a support structure for supporting multiple heat exchange tubes and multiple fins arranged at intervals. Under the support of the fixture for the heat exchange tubes and the fins, the heat exchange tubes and the fins are welded and fixed at the positions of the welding holes, so that the heat exchange tubes and the fins are connected as one piece. After completing the welding process, the fixture is removed and other installation and manufacturing processes of the heat exchanger are arranged.

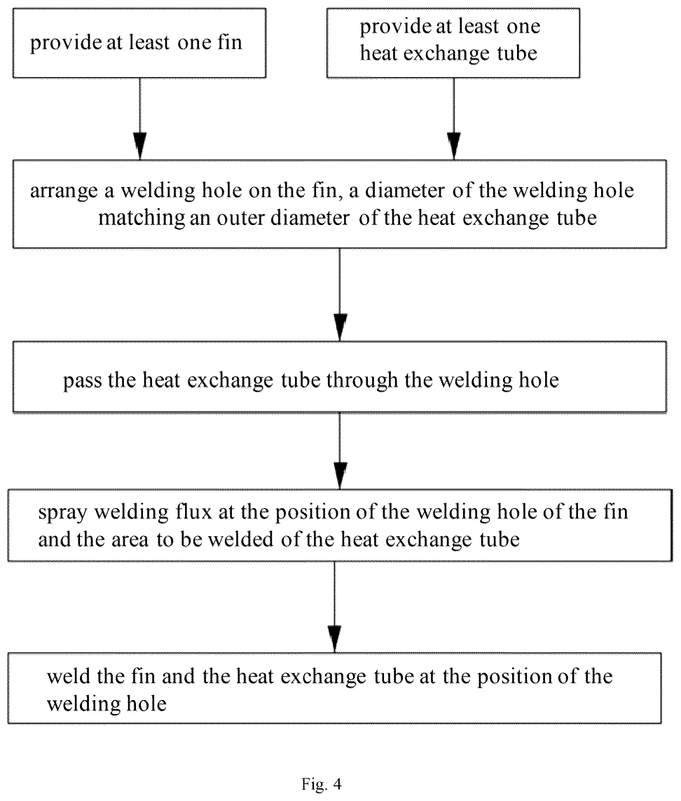

In an embodiment of the method for manufacturing a heat exchanger of the present application, referring to FIG. 4, after fixing the relative position of the heat exchange tube and the fin, the method further includes a step of spraying welding flux on the welding hole area of the fin and the area to be welded of the heat exchange tube. After fixing the relative positional relationship between the heat exchange tube and the fin and before welding the heat exchange tube and the fin, the welding flux is evenly distributed to the fin and the area to be welded of the heat exchange tube in a spraying manner to ensure the welding quality of the welding area.

When the heat exchanger has multiple heat exchange tubes and multiple fins, there are multiple areas to be welded between the heat exchange tubes and the fins, and the multiple areas to be welded are spaced apart from each other. The welding flux is sprayed on each of the areas to be welded, so that the heat exchange tubes and the fins are firmly welded and fixed at each connection position, improving the overall connection strength of the heat exchange tubes and the fins.

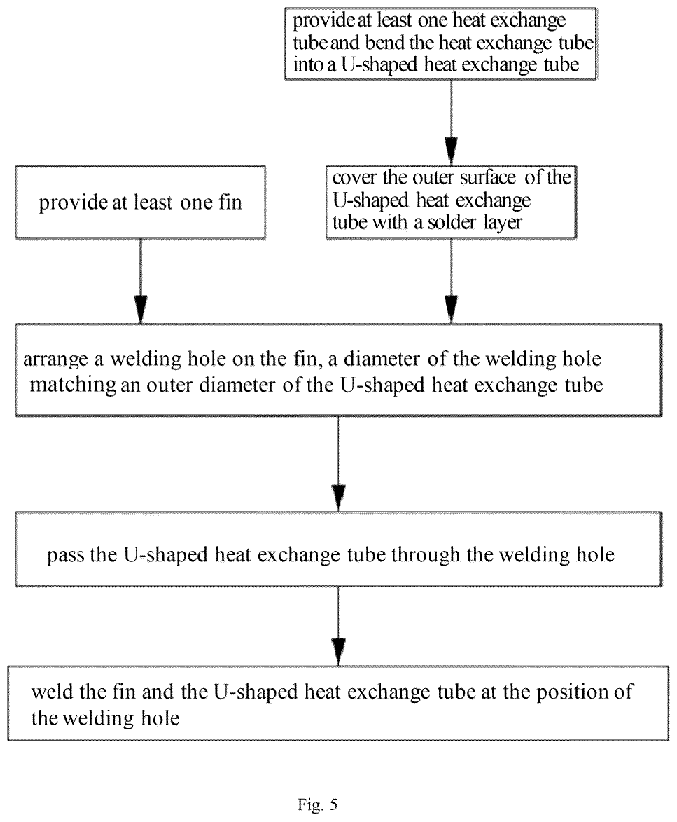

In an embodiment of the method for manufacturing a heat exchanger of the present application, referring to FIG. 5, the method further includes the steps of:
providing a heat exchange tube body; and
bending the heat exchange tube body into a U-shaped heat exchange tube;
the method may also include the following steps:
passing the U-shaped heat exchange tube through the welding hole of the fin and fixing the relative positional relationship between the U-shaped heat exchange tube and the fin; and
welding the fin and the U-shaped heat exchange tube at the position of the welding hole.

In the method for manufacturing a heat exchange tube of this embodiment, by adding a bending process, the heat exchange tube is bent into a U-shaped heat exchange tube, so as to reduce the welding positions between the heat exchange tubes and thus reduce the unreliability of the connection positions of the heat exchange tubes.

The bending process can be set after the step of covering the outer surface of the heat exchange tube with a solder layer. The solder layer is arranged at the entire continuous heat exchange tube; in the continuous process, the solder layer on the heat exchange tube is more uniform, and the thickness and uniformity of the solder layer will not be affected by the bending area. The heat exchange tube covered with the solder layer is welded to the fins simultaneously at any position on the heat exchange tube, and each position ensures a high welding connection strength between the heat exchange tube and the fins. Therefore, the welding position of the heat exchange tube does not need to be set in advance, and the heat exchange tube can be welded at the position of the welding hole of any fin according to actual needs, making the heat exchange tube have higher adaptability to the welding process.

The bending process can also be set before the step of covering the outer surface of the heat exchange tube with a solder layer; the heat exchange tube is bent first, and then the solder layer is arranged at the outer surface of the U-shaped heat exchange tube. Compared with the entire heat exchange tube before bending, the U-shaped heat exchange tube has a shorter effective length and occupies less space. Therefore, the U-shaped heat exchange tube is more suitable for soaking in solder a solution, and there is no strict length requirement for a container that contains the solder solution.

In the step of arranging a solder layer on the surface of the heat exchange tube, the outer surface of the heat exchange tube can be soaked in a solder solution to form a solder layer on the outer surface of the heat exchange tube.

Similarly, the fin can also be placed in a solder solution to form a solder layer on the outer surface of the fin. By soaking in the solder solution, a solder layer can be arranged at the outer surface of the heat exchange tube or the outer surface of the fin, which has the advantage of being simple and easy to operate. The solder layer can be arranged at various positions on the outer surface of the heat exchange tube or the fin.

The above method of arranging the solder layer on the outer surface of the heat exchange tube is particularly suitable for heat exchange tubes made of aluminum-based materials and heat exchange tubes made of copper-based materials. It is also applicable to other heat exchange tubes with multi-layer structures.

Local areas of the heat exchange tube can also be soaked in a solder solution, and a solder layer can be arranged in a specific area of the heat exchange tube. The heat exchange tube arranged with the solder layer can be passed through the welding hole of the fin, and a section of the heat exchange tube that is provided with the solder layer can be welded and fixed to the fin. This arrangement requires setting the welding position on the heat exchange tube in advance, and the welding process of the heat exchange tube and the fin is completed according to the preset welding position.

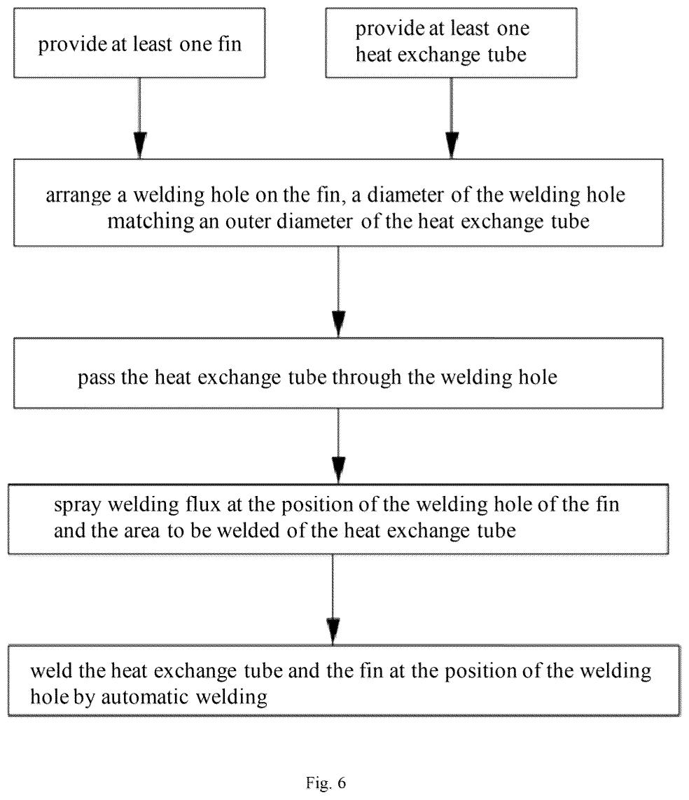

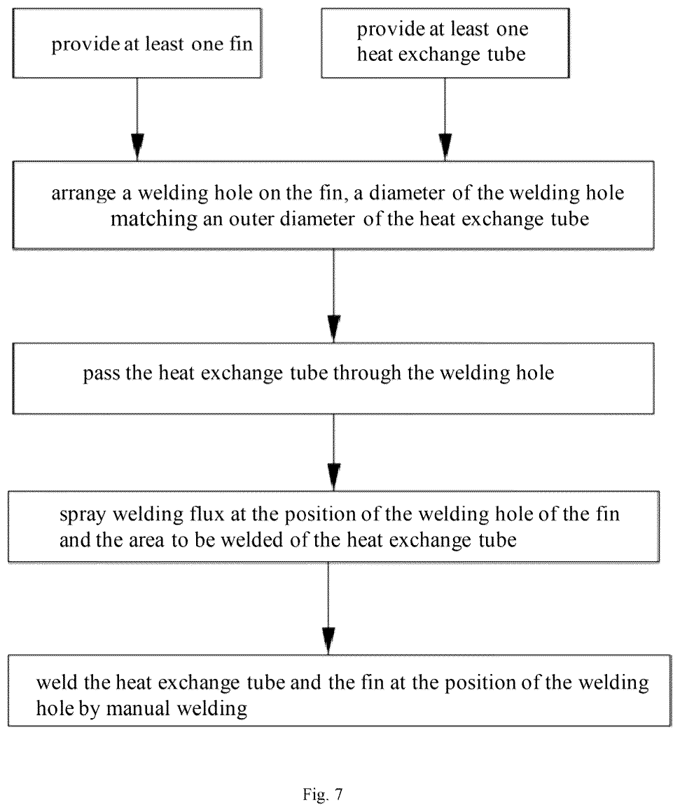

In an embodiment of the method for manufacturing a heat exchanger of the present application, referring to FIGS. 6 and 7, in the step of welding the fin and the heat exchange tube at the position of the welding hole, the heat exchange tube and the fin are welded at the position of the welding hole by automatic welding or manual welding. The specific welding method can be brazing or other welding methods according to actual needs, and the welding method is not specifically limited in this embodiment.

It should be noted that the welding process of the heat exchanger includes the welding between the heat exchange tube and the fin, as well as the welding between the heat exchange tubes. The heat exchange tubes also include manifold tubes, splitter tubes, distribution tubes, and capillary tubes, etc. The welding process is also required between different heat exchange tubes. Therefore, different welding processes can be set according to actual needs and the specific position of the heat exchanger, so that different heat exchange tubes all have high connection strength.

In the method for manufacturing a heat exchanger according to any one of the above embodiments provided in the present application, in some embodiments heat exchange tubes can be made of aluminum-based materials and/or copper-based materials. Aluminum-based materials and copper-based materials have excellent thermal conductivity, and aluminum-based materials also have excellent characteristic of anti “ant hole corrosion,” as well as the advantages of low cost and recycling.

Since the method for manufacturing a heat exchanger of the present application has a small influence on the structure inside the heat exchanger tube, a tooth shaped structure can be arranged inside the heat exchanger tube. The function of the tooth shaped structure is to increase the contact area between the heat exchanger tube and the refrigerant medium inside it. Compared with the existing mechanical tube expansion structure, the manufacturing methods in different embodiments of the present application all ensure that the tooth shaped structure has good integrity and no wear during the manufacturing process.

The present application also provides a heat exchanger 300, which is manufactured using the method for manufacturing a heat exchanger according to any one of the above embodiments, and which may also have the specific structure involved in any one of the above embodiments. In the heat exchanger 300 of the present application, a refrigerant medium is introduced into a heat exchange tube 200; the heat exchange tube 200 and a fin 100 connected to the heat exchange tube 200 exchange heat with the refrigerant medium. The heat exchanger of the present application has high heat exchange efficiency for the following two reasons:
one of the reasons is that welding is used to ensure a high connection strength between the heat exchange tube and the fin, as well as excellent thermal conductivity, allowing for good heat exchange between the refrigerant medium and the outside; and
the other reason is that welding is used to reduce the wear of the tooth shaped structure inside the heat exchange tube during the manufacturing process, resulting in a larger heat exchange area of the heat exchange tube and higher heat exchange efficiency of the overall heat exchanger.

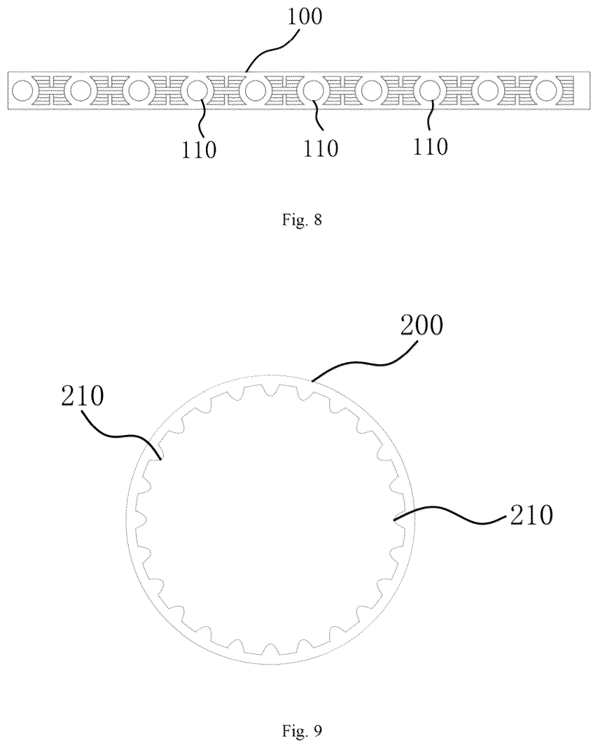

As shown in FIG. 8, the fin 100 of the heat exchanger 300 is provided with multiple welding holes 110 for the heat exchange tubes 200 or U-shaped heat exchange tubes 220 to pass through. The heat exchange tubes 200 or U-shaped heat exchange tubes 220 are welded and fixed in the welding holes 110 of the fins 100 using the manufacturing method described in any one of the above embodiments.

As shown in FIG. 9, an inner wall of the heat exchange tube 200 of the heat exchanger 300 is provided with flow guide teeth 210, which can be integrally formed on the inner wall of the heat exchange tube 200. The heat exchange tube in FIG. 9 is provided with multiple flow guide teeth 210, which increase the heat exchange area of the heat exchange medium in the heat exchange tube. In the heat exchanger 300 provided in the present application, welding process is used to fix the heat exchange tube in the welding hole 110 of the fin, ensuring the integrity of the flow guide teeth during the manufacturing process of the heat exchanger 300. Compared with mechanical tube expansion, the present application has obvious advantages.

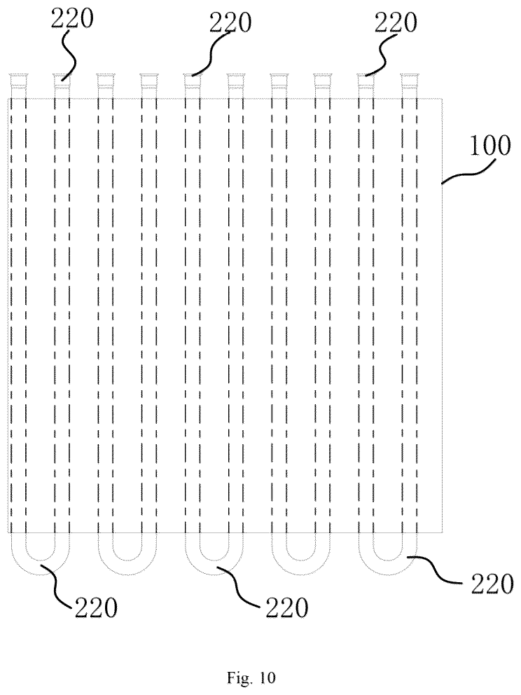

As shown in FIG. 10, in an embodiment of the heat exchanger 300 provided in the present application, multiple U-shaped heat exchange tubes 220 are passed through the welding holes 110 of the fins 100. The combined U-shaped heat exchange tubes and fins can be placed in a heating furnace, and the manufacturing method described in any one of the above embodiments can be used to control the temperature inside the heating furnace and weld them as a whole, which is advantageous for improving the manufacturing efficiency of the heat exchanger.

In summary, in the heat exchanger 300 provided in the present application, the heat exchange tubes and the welding holes of the fins are fixedly connected using welding process, ensuring the integrity of the flow guide teeth inside the heat exchange tubes, and enabling the heat exchanger 300 to have a high heat exchange area and high heat exchange efficiency. The flame temperature is controlled within a reasonable range, and the heat exchange tubes and the fins are made of the same type of metal material, such as aluminum-based materials or copper-based materials, so as to reduce deformation of the heat exchange tubes and the fins.

The present application also provides an HVAC apparatus, which includes the heat exchanger as described above.

Described above are only some specific embodiments of the present application, but the scope of protection of the present application is not limited to this. Any changes or replacements that can be easily conceived by those skilled in the art within the technical scope disclosed by the present application should be covered within the scope of protection of the present application. Therefore, the scope of protection of the present application should be accorded with the scope of protection of the claims.

1. A method for manufacturing a heat exchanger comprising:
providing a fin and a heat exchange tube, a welding hole being arranged at the fin, and flow guide teeth being arranged at an inner wall of the heat exchange tube;
passing the heat exchange tube through the welding hole; and
welding the fin and the heat exchange tube at a position of the welding hole.

2. The method according to claim 1, further comprising, before welding the fin and the heat exchange tube:
covering an outer surface of the heat exchange tube with a solder layer.

3. The method according to claim 2, further comprising, before welding the fin and the heat exchange tube:
covering an outer surface of the fin or an area to be welded at the welding hole with a solder layer.

4. The method according to claim 3, further comprising, before welding the fin and the heat exchange tube and after passing the heat exchange tube through the welding hole:
spraying welding flux at the position of the welding hole of the fin and an area to be welded of the heat exchange tube respectively.

5. The method according to claim 3, wherein welding the fin and the heat exchange tube includes:
fixing the heat exchange tube passed through the welding hole and the fin so that the heat exchange tube and the fin maintain an attitude for welding;
placing the heat exchange tube and the fin that maintain the attitude for welding inside a heating furnace; and
welding the heat exchange tube and the fin at the position of the welding hole using automatic welding.

6. The method according to claim 2, further comprising, before welding the fin and the heat exchange tube and after passing the heat exchange tube through the welding hole:
spraying welding flux at the position of the welding hole of the fin and an area to be welded of the heat exchange tube respectively.

7. The method according to claim 5, wherein welding the fin and the heat exchange tube includes:
fixing the heat exchange tube passed through the welding hole and the fin so that the heat exchange tube and the fin maintain an attitude for welding;
placing the heat exchange tube and the fin that maintain the attitude for welding inside a heating furnace; and
welding the heat exchange tube and the fin at the position of the welding hole using automatic welding.

8. The method according to claim 2, further comprising:
processing the heat exchange tube, including:
providing a heat exchange tube body; and
bending the heat exchange tube body into a U-shaped heat exchange tube.

9. The method according to claim 2, wherein covering the outer surface of the heat exchange tube includes:
soaking the outer surface of the heat exchange tube in a solder solution to form the solder layer on the outer surface of the heat exchange tube.

10. The method according to claim 2, wherein welding the fin and the heat exchange tube includes:
fixing the heat exchange tube passed through the welding hole and the fin so that the heat exchange tube and the fin maintain an attitude for welding;
placing the heat exchange tube and the fin that maintain the attitude for welding inside a heating furnace; and
welding the heat exchange tube and the fin at the position of the welding hole using automatic welding.

11. The method according to claim 1, further comprising, before welding the fin and the heat exchange tube:
covering an outer surface of the fin with a solder layer, or covering an area to be welded at the welding hole with a solder layer.

12. The method according to claim 11, wherein welding the fin and the heat exchange tube includes:
fixing the heat exchange tube passed through the welding hole and the fin so that the heat exchange tube and the fin maintain an attitude for welding;
placing the heat exchange tube and the fin that maintain the attitude for welding inside a heating furnace; and
welding the heat exchange tube and the fin at the position of the welding hole using automatic welding.

13. The method according to claim 1, further comprising, before welding the fin and the heat exchange tube and after passing the heat exchange tube through the welding hole:
spraying welding flux at the position of the welding hole of the fin and an area to be welded of the heat exchange tube respectively.

14. The method according to claim 1, wherein welding the fin and the heat exchange tube includes:
fixing the heat exchange tube passed through the welding hole and the fin so that the heat exchange tube and the fin maintain an attitude for welding;
placing the heat exchange tube and the fin that maintain the attitude for welding inside a heating furnace; and
welding the heat exchange tube and the fin at the position of the welding hole using automatic welding.

15. The method according to claim 14, wherein the heat exchange tube is made of at least one of aluminum-based material or copper-based material.

16. The method according to claim 15, wherein providing the heat exchange tube includes:
integrally forming the heat exchange tube with the flow guide teeth on the inner wall of the heat exchange tube, the flow guide teeth being configured for heat exchange with a medium inside the heat exchange tube.

17. The method according to claim 14, wherein providing the heat exchange tube includes:
integrally forming the heat exchange tube with the flow guide teeth on the inner wall of the heat exchange tube, the flow guide teeth being configured for heat exchange with a medium inside the heat exchange tube.

18. A heat exchanger comprising:
a fin, a welding hole being provided at the fin; and
a heat exchange tube, an inner wall of the heat exchange tube being provided with flow guide teeth;
wherein the heat exchange tube is passed through the welding hole and fixedly connected to the fin by welding.

19. An HVAC apparatus comprising:
a heat exchanger including:
a fin, a welding hole being provided at the fin; and
a heat exchange tube, an inner wall of the heat exchange tube being provided with flow guide teeth;
wherein the heat exchange tube is passed through the welding hole and fixedly connected to the fin by welding.
